(19) United States
(12) Patent Application Publication
(10) Pub. No.: US 2009/0324795 A1
(43) Pub. Date: Dec. 31, 2009

(54) Cheese products with form stability and deep-frying stability

(76) Inventor: Hopfl Dieter, Limburgerhof (DE)

Correspondence Address: Hopfl Dieter, Wilhwlm Busch Strasse 35, LImburgerhof, 67117, DE

(21) Appl. No.: 12/309,220

(22) PCT Filed: Nov. 7, 2007
(86) PCT No.: PCT/EP2007/006154

§ 371 Date: Jan. 12, 2009

(30) Foreign Application Priority Data
Jul. 13, 2006 (DE) 10 2006 032 385.8

(51) Int. Cl. A23C 19/09; A23C 19/082

(52) U.S. Cl. 426/582

(57) ABSTRACT

The present invention relates to a novel cheese-containing heat-stable composition which can be fried. The composition can be produced using different cheese types and flavours. In addition to cheese, the use of maize and/or maize meal is essential in implementation of the invention. By varying the components, as required, products for different flavour directions, for example reduced-fat or else sweet or piquant etc., can be produced. The fried finished product can have the shape of chips and can also be used as a chip substitute. In the production, the components and the flavouring ingredients are melted in a suitable melting machine with intense stirring and brought into the desired shape. After cooling, a solid composition is formed which can then be fried and is heat stable.

Cheese products with form stability and deep-frying stability

The present invention comprises cheese products with form stability and deep-frying stability, a stabilizing agent for use in production of the cheese products and a production method.

Natural cheese generally have low melting points, so that they deliquesce under exposure to heat and lose their form. Therefore, natural cheeses are suitable under a limited range of conditions only for use in products subjected to heat (e.g. cheese cubes in scalded sausage, grilling cheese). The state of the art already includes a number of cheese products with heat stability and deep-frying stability.

One method of rendering natural cheeses heat-stable (i.e. form stability when exposed to heat) is to coat them with material that forms an impermeable barrier under exposure to heat, thus preventing the cheese from flowing out when it melts under heat exposure. Such breaded cheese products are also characterized by deep-frying stability.

EP 10 37 536 describes a bakeable cheese product and a production method for same. This product comprises a cheese core and at least one or more layers of material surrounding this core so as to prevent the cheese core from flowing out when heated. The cheese core may contain, for example, various cheese types as well as other foodstuffs such as ham or flavouring agents.

The outer layer comprises breadcrumbs or bread dough along with substances that fortify the crust during frying such as semolina, grains of cheese, crushed nuts, etc. or starch grains, preferably tapioca. This layer preferably also contains a browning agent. When baked, this layer forms a solid crust. The weight ratio of cheese to grains or starch in the outer layer or crust is preferably 5:1.

The disadvantage of this product is that the crust burns quickly during baking, with a possible negative influence on the taste, and that the cheese core melts and flows out when cut, i.e. does not possess form stability.

In JP 2001-06991.1 a boil-resistant soft processed cheese product is described that contains, in addition to cheese, protein (alpha-casein), emulsifier in the amount of 5 to 50% by weight and melting salts, as well as a natural polysaccharide that acts as a thickener. This polysaccharide has a molecular weight within the range of 10,000 to 1 million; chemically it is an alpha-1.4,alpha-1.6 glucan. It is, however, not suitable for deep-frying, since it is not form-stable at the temperatures used in this cooking process, i.e. it melts.

In JP 2182148, a boil-resistant cheese is described that is modified by admixture of fish meal and melting salts and can be used heated and added to soups or sauces without losing its form. The drawbacks in this case, however, include the pronounced fishy taste and lack of stability when deep-fried.

Furthermore, heat-stable raw cheeses are known that achieve heat stability by means of exposure to an additional thermal treatment during raw cheese production or are made with form-stabilizing additives.

U.S. Pat. No. 5,573,806 describes production of a boil-resistant cheese characterized by the fact that the cheese mass contains 20 to 22% proteins by weight, approx. 300-600 mg calcium pro 100 g, approx. 18 to 21% fat by weight and 48-55% water by weight. The pH level of the mass is approx. 5.1 to 5.5. The disadvantage of this mass is that it cannot be processed in a deep fryer.

WO03/051133 describes another production method for a heat-stable cheese product characterized by use of a raw cheese or raw cheese mass and introduction of a hot liquid (e.g. in water or whey) at max. 70° C. for a period of 5 to 60 minutes to denature the cheese on the outside and change its consistency so as to render it heat-stable after the treatment, i.e. so it can be toasted and deep-fried. The mass obtained by this method is, however, still not form-stable when it is deep-fried.

DE 69727754 describes production of a heat-stable natural cheese or natural cheese product by means of addition of a coagulable protein (1-10%) during

Another production method for heat-stable cheese products is based on soft processed cheese. Soft processed cheese is made from natural cheese to which other ingredients and additives are added such as fats, water and melting salts are added, for instance by means of chopping, mixing, heating and emulsifying. The soft processed cheese industry uses various melting machine designs. The cheese mass is heated either directly with steam or indirectly to temperatures between 70 and 140° C.. A wide variety of soft processed cheese products with many different properties, including heat stability, can be produced by varying the process parameters and the recipe. Heat-stable soft processed cheeses that generally retain their form when baked, fried or grilled comprise the current state of the art. These cheeses can be produced in many variations by changing the recipes (cheese type, melting salts, etc.) process parameters (temperature, exposure time, etc.). When boiled or heated in a microwave oven, the material is heated by the presence of water up to 100° C. During baking, frying and grilting, the exterior temperature is higher due to fat or drying, but the core temperatures also remain below 100° C.. In a microwave oven, additional form-altering forces are at work due to increased water vapour pressure inside the foodstuff.

During deep-frying, however, the water in the outer layers evaporates very quickly and is replaced by fat, so that these parts are heated to a deep-frying temperature of 160 to 200° C., whereby they lose their form.

US 2005/0196509 describes a cheese mass suitable for the microwave oven. The mass contains natural cheese, cheese analogues or cheese powder (soft processed cheese mass) as well as so-called “melt-restriction agents” i.e. agents that prevent melting as well as melting salts, phosphates in amounts ranging from 0.1 to 2% by weight, fat and other commonly used additives. The agents that prevent melting include the various starches or cellulose. The protein content of this mass is 15 to 40% by weight, the fat content 10 to 60% by weight, the water content approx. 45-60% by weight. This cheese mass is suitable, based on this composition, for use in microwave ovens, in which it shows melting stability for a period of 10 minutes. It cannot, however, be deep-fried, since it lacks the necessary form stability. cheese production with a coagulation temperate of between 70 and 80° C.. When the raw cheese is heated, the protein is denatured and the structure of the cheese is solidified to a considerable extent. This mass can then be further ripened into cheese. Form alteration under the influence of heat is max. 10%. The example is mentioned of heating it in an oven set at 150° C., under which conditions a 3-4% deformation was registered, depending on the recipe. However, this mass is no longer form-stable when deep-fried.

Deep-frying is a unique heating process in which fat heated to a temperature of 160 to 200° C. quickly evaporates the water out of the product and takes its place. On the one hand, this results in very rapid heating of the product. On the other hand, the structural stability of a product can also be influenced to a great extent by this procedure. The known state-of-the-art cheese products are, despite heat-stability at temperatures from 160 to 200° C., not form-stable when deep-fried. A cheese product with deep frying stability that can be freely altered in taste, nutrient content, form, etc. without use of a coating, e.g. for production of “cheese French fries” is not yet known among state-of-the-art products.

Based on this state of the art, the task was defined of developing a cheese product that goes beyond the conditional heat stability of known products in that it is also sliceable and is characterized by deep-frying stability without a coating. The form stability of the product during deep-frying is of decisive importance.

The task as defined above was achieved, surprisingly, by the present invention. Accordingly, these cheese products with form stability and deep-frying stability are characterized by the fact that they contain the following components a) to f):

a) Cheese 10 to 60% by weight, preferably 20 to 50% by weight, such as natural cheese and/or unripened cheese and/or soft processed cheese and/or cheese powder

b) Maize flour and/or maize semolina 5 to 35% by weight, preferably 10 to 25% by weight

c) Starch 0 to 30% by weight, preferably 5 to 15% by weight, such as native and/or modified starches from potatoes, wheat, maize, manioc and/or other

d) Melting salts 0.1 to 5% by weight, preferably 0.5 to 4% by weight, including phosphates and/or citrates and mixtures thereof

e)Additives 0 to 5% by weight, preferably 0.1 to 3% by weight

f) Fat 0-10% by weight

g) Water supplementing the above material proportions to make 100% by weight

The object of the present invention is, furthermore, a stabilizing agent in powder form used in production of the cheese product according to the invention with form stability and deep-frying stability and contains the following components b) to e):

b.) Maize flour and/or maize semolina in amounts of 50 to 99% by weight,

c.) Starch and/or other milled grain products in amounts of 0 to 49% by weight,

d.) Melting salts in amounts from 0.3 to 10% by weight

e.) Additives in amounts from 0 to 10% by weight

The user need only add to this stabilizing agent the components a) cheese and, as required, the components f) fat and g) water.

Production of the cheese product according to the invention, with form stability and deep-frying stability, is realized by mixing the powdered stabilizing agent with the cheese and the water, after which the mixture is melted in a melting machine by application of heat and mechanical processing. The mass thus obtained is then further processed to obtain forms as described below.

Production of the cheese products according to the invention, with form stability and deep-frying stability, using all components is realized as follows:

Components a) to g) are mechanically processed and are thereby heated in a melting machine to 70 to 140° C., preferably to 80 to 95° C. for 2-20 minutes, melted and processed to produce the cheese mass according to the invention by being filled into forms, then cooled.

An essential advantage inheres in the fact that, after heating, the hot cheese mass can be poured directly into the desired final form, or also into strips or larger blocks, then later cut into strips (French fries form), cubes, slices, etc.. The form products thus produced can be deep-fried without losing their form. On the outside, deep-frying forms a thin, crispy, very appetizing, golden-brown crust, whereby the core is heated all the way through, but does not melt.

A further essential advantage inheres in the fact that cheese in every processing stage (e.g. also unripened cheese, feta cheese, cheese powder, etc.) can be used for this cheese mass by modifying the recipe. No specific raw cheese product is required for this purpose. The character of the final product, e.g. its taste, is influenced to an essential degree by the raw cheese product used.

A further advantage inheres in the fact that this product can be produced using the existing equipment of soft processed cheese manufacturers. No additional complex process steps are required.

A further advantage inheres in the fact that the product can be stored and further processed in a variety of ways. It makes no difference whether the products have been stored refrigerated or deep-frozen. It is also possible to store the deep-fried products refrigerated or deep-frozen. Pre-deep-fried products are then suitable for fat-free heating in a baking or microwave oven without losing their form.

A further advantage inheres in the fact that various different additives to create different tastes (spices, herbs, flavourings) and colours (colorant foodstuffs, food colours) can be added to the cheese mass to facilitate product of a wide range of products.

A further advantage inheres in the fact that the recipes can be varied so that for instance a cheese product that is deep-frying stable (e.g. ass a substitute for steak) can be produced as well as a cheese snack that is deep-frying stable (e.g. cheese fries, cheese cubes, cheese kebab, cheese tarts). They can also be used as form-stable soup fortifiers. Products with low fat contents and low dry matter levels can also be used as side dishes (e.g. cheese croquettes, flat cakes, cheese fries).

More detailed descriptions of the individual components follow.

Cheese

This includes, according to the invention, cheese, e.g. all types of natural cheese (hard, sliceable and soft cheese) such as Emmentaler, Cheddar, Gouda, Edamer, Feta, unripened cheese etc.. Furthermore, soft processed cheese of all types can be used. The above cheeses contain, depending on the provenance, up to 85% by weight water. This factor must be taken into account when calculating the amount of additives. Addition of 10 to 30% by weight dry cheese mass is preferable to achieve a strong cheese flavour. Cheese can also be replaced partially by other proteins such as milk protein, whey proteins or soy proteins (such as tofu). All natural and soft processed cheese types can also be used in the form of cheese powder. Cheese powder serves as a partial or complete replacement for natural and soft processed cheese.

Maize Flour and Maize Semolina

Maize flour and maize semolina are milled products of maize grains. Maize flour products of different grains sizes and milling grades can be used. When cooked, maize serves, together with the other components, to form a stable structure in the solidification phase in which water is also bound fast so that the mass, after hardening, is deep-frying stable and form-stable and does not take up large amounts of fat. Furthermore, maize provides an optical advantage to the cheese mass with its golden yellow colour.

Starch/Milled Grain Products

Starches are obtained from various different raw materials, e.g. wheat, potatoes and maize. They may be in the form of native or modified starches. The type of chemical modifications is signified by the E number. The specific starch type is not essential to the invention. In combination with maize flour, the starches serve the purpose of loosening and softening the consistency of the deep-fried product, whereby they partially replace the maize flour. It is also possible to replace part of the flour with other milled grain products, e.g. wheat flour, wheat semolina, rice flake semolina, etc.

Melting Salts

A number of different phosphates and citrates can be used as melting salts. These include, among others, the sodium salts of the polyphosphates, the sodium/potassium and calcium salts of the monophosphates and/or the sodium/potassium salts of the diphosphates and/or the sodium/potassium salts of the triphosphates and/or sodium/potassium citrates. These salts can be used single or in mixtures. The amount of melting salt is 0.1 to 5% by weight, preferably however 0.5 to 4% by weight.

Additives

Additives that can be used according to the invention are the preservative agents, colorants and flavourings known and approved for use in the food manufacturing industry.

Other Additions

It is also possible, as required, to change the taste of the cheese mass by adding pieces of ham, herbs, nuts, chocolate, onions and similar foodstuffs.

Fat

To facilitate melting during production of the cheese products and to optimize the taste, it may be necessary, in particular with very low-fat cheeses to add additional fat. The fat content in the dry matter can thus be adjusted to 10-40% by weight, and especially to 15-30% by weight. Suitable fats include vegetable or animal fats and oils, in particular butter, palm fat and sunflower seed oil.

The following examples further clarify the invention without delimiting it. Unless otherwise indicated, percentage data are to be understood as percent by weight.

### EXAMPLE 1

### Production of “Cheese Fries”

10-50% by weight chopped natural or soft processed cheese or 5-20% cheese powder, 10-20% by weight maize flour, 5-10% by weight potato starch, 0.5-3% by weight melting salts, 0.5-2% by weight salt, 0.1-0.5% by weight citric acid and 30-60% by weight water are mixed homogeneously in the melting machine, then heated by means of direct/indirect steam injection to temperatures between 70 and 140° C.. After approx. 2-20 minutes of heat exposure time, the hot cheese mass is filled into a block form, e.g. 80×80×280 mm, and cooled. Cooling and hardening takes 10-48 hours at temperatures between 1 and 15° C., preferably 4-8° C., in a cooler. The block is then cut into slices, and afterwards into strips, e.g. 8×8×80 mm. The cheese strips produced by this method can be packaged and stored before they are deep fried, or they can be deep-fried first, then cooled, packaged and stored. The cheese strips, whether non-deep-fried, pre-deep-fried or otherwise pre-cooked, can be stored refrigerated or deep-frozen. Pre-deep-fried cheese strips can be prepared by the end consumer by means of deep-frying or in a baking or microwave oven without further addition of fat.

### EXAMPLE 2

### Production of “Filled Cheese Tarts and/or Cheese Rolls”

10-50% of a chopped natural or soft processed cheese or 5-20% of a cheese are mixed homogeneously in the melting machine with 10-20% maize flour, 5-10% potato starch, 0.5-3% melting salts, 0.5-2% salt, 0.1-0.5% citric acid and 30-60% water, then heated by means of direct/indirect steam injection to temperatures between 70 and 140° C.. The heat exposure time is 2-20 minutes.

The hot mass then rolled out to the desired thickness of, e.g., 0.5-2 mm. The cheese dough is cooled to room temperature so that it is no longer sticky, but still flexible and therefore can still be processed into cheese tarts or cheese rolls. The dough can then be cut into a variety of forms, e.g. rectangles. These are then either covered with any of a number of fillings and rolled together or folded to make tarts. The cheese rolls are pinched together slightly at the ends. When fried, the layers adhere to one another and prevent the filling from falling out. The cheese tarts are pressed together by application of mechanical pressure at the open ends similarly to conventional tarts. The cheese rolls or cheese tarts prepared by this method can then, after final hardening, be deep-fried without further preparation.

EXAMPLES FOR COMPARISON

Standard recipe comprising:

30% Cheddar (62% dry matter, 50% fat in dry matter)

17.4% Maize/starch/milled grain products (dry matter)

1.5% Melting salts (polyphosphate)

0.7% Sodium chloride

0.3% Artificial flavourings, type Gouda

Water ad 100%

Preparation of the sample was as per Example 1. A test object 39 mm in diameter was cut out of a slice of the sample 14 mm thick, then exposed to the various heat sources and levels. Under this exposure, the forms were preserved to varying degrees.

| | Deep fryer | Microwave | Baking oven | Boiling water |
|---|---|---|---|---|
| | (170° C./ | (600 W, | (220° C., | (100° C./ |
| | 3 min) | 1 min) | 5 min) | 3 min |
| Maize flour | 1 | 2 | 1 | 1 |
| Potato starch | 5 | 4 | 3 | 3 |
| Wheat flour | 2-3 | 3 | 1 | 2 |
| 50:50 maize | 1-2 | 3 | 1 | 2 |
| flour/potato | | | | |
| starch | | | | |
| Rice flour | 5 | 4 | 3 | 3 |

1 - Complete preservation of form (sharp edges, smooth surfaces, hard after cooling)
2 - Form essentially preserved (edges not sharp, surfaces sunken, slightly distorted form, soft after cooling)
3 - Form essentially lost (test object deliquesces, but a closed, circular form remains, bumps still recognizable, very soft after cooling)
4 - Complete loss of form (complete deliquescence, no structure recognizable)
5 - Torn apart during deep-frying

1. Cheese products with form stability and deep-frying stability, characterized by containing the following components a) to g):
a) Cheese 10 to 60% by weight
b) Maize flour and/or maize semolina 5 to 35% by weight
c) Starch and/or other milled grain products 0 to 30% by weight
d) Melting salts 0.1 to 5% by weight
e) Additives and additions 0 to 5% by weight, preferably 0.1 to 3% by weight
f) Fat 0 to 10% by weight
g) Water supplementing the material proportions to make 100% by weight

2. Cheese products with form stability and deep-frying stability according to claim 1, characterized by containing 20 to 50% by weight natural cheese and/or unripened cheese and/or soft processed cheese and/or cheese powder.

3. Cheese products with form stability and deep-frying stability according to claim 1, characterized by containing 10 to 25% by weight maize flour and/or maize semolina.

4. Cheese products with form stability and deep-frying stability according to claim 1, characterized by containing 5 to 15% by weight native and/or modified potato, wheat, maize, manioc starches.

5. Cheese products with form stability and deep-frying stability according to claim 1, characterized by containing 5 to 20% by weight milled grain products.

6. Cheese products with form stability and deep-frying stability according to claim 1, characterized by containing 0.5 to 4% by weight melting salts, such as phosphates and/or citrates, as well as mixtures of same.

7. Cheese products with form stability and deep-frying stability according to claim 1, characterized by containing 0.1 to 3% by weight additives such as preservative agents, colorants and flavourings.

8. Cheese products with form stability and deep-frying stability according to claim 1, characterized by containing further additions such as herbs, ham pieces, nuts, chocolate, onions, etc..

9. Production method for cheese products with form stability and deep-frying stability employing raw materials as per claims 1 to 8, characterized by heating components a) to g) in a melting machine, while mechanically processing them, to 70 to 140° C., preferably to 80 to 95° C., whereby the mass is kept hot for between 2-20 min, then poured into forms, cooled, hardened and subsequently, as required, cut or otherwise processed so as to take on the desired forms.

10. Stabilizing agent for production of cheese products with form stability and deep-frying stability according to claims 1 to 6, characterized by containing components b to f
b.) Maize flour and/or maize semolina in amounts of 50 to 99% by weight,
c.) Starch and/or other milled grain products in amounts from 0 to 49% by weight
d.) Melting salts in amounts from 0.3 to 10% by weight
e.) Additives in amounts of 0 to 10% by weight.

11. Using the stabilizing agents according to claim 10 in the production process according to claim 9 to produce the cheese products with form stability and deep-frying stability.
